(19) United States
(12) Patent Application Publication
(10) Pub. No.: US 2010/0212193 A1
(43) Pub. Date: Aug. 26, 2010

(54) UNIVERSALLY MOUNTABLE LANDSCAPING APPARATUS AND METHODS

(76) Inventor: Bradley Wayne Kostyak, Carlisle, PA (US)

Correspondence Address: Saul Ewing LLP (Harrisburg);Attn: Patent Docket Clerk, Penn National Insurance Plaza, 2 North Second Street, 7th Floor, Harrisburg, PA, 17101, US

(21) Appl. No.: 12/713,800

(22) Filed: Feb. 26, 2010

Related U.S. Application Data
(60) Provisional application No. 61/208,585, filed on Feb. 26, 2009.

(51) Int. Cl. E02F 3/96; F16B 1/00; B23P 11/00

(52) U.S. Cl. 37/405; 403/291; 29/428

(57) ABSTRACT

A landscaping tool for attachment to the bucket of a landscaping vehicle with the use of removable load securing devices. Installation of the landscaping apparatus is accomplished quickly and without the need for any preexisting mounting holes to be present in the bucket or in the landscaping tool. The tool generally comprises an elongated plate having two opposite longitudinal working edges and a plurality of integrally formed tapered teeth protruding from each working edge. The two longitudinal surfaces also contain a series of connection brackets which enable the landscaping tool to securely engage the bucket. Load securing devices are routed around the back of the bucket to provide tension to the connection brackets in turn securely attaching the landscaping apparatus to the bucket.

### CROSS-REFERENCE TO OTHER APPLICATIONS

This application claims priority to U.S. Provisional patent application Ser. No. 61/208,585, filed Feb. 26, 2009.

### BACKGROUND OF THE INVENTION

This invention relates to landscaping apparatus and methods, and more particularly, to apparatus and methods for grading, raking, and leveling of soil using skidloaders, tractors, and other powered landscaping vehicles and equipment.

Landscaping is an essential part of virtually any construction project, and is particularly critical to the final stages of construction. For example, grading and leveling of soil is necessary to ensure proper rainfall drainage, scarifying is necessary to remove large rocks and debris, and raking is required to smooth soil and remove smaller rocks and debris prior to installation of driveways and walkways, as well as to cultivate prior to lawn seeding. The use of highly maneuverable skid loaders has reduced the amount of manual labor required for the above-described landscaping tasks. Additionally, skid loaders include hydraulic lift arms and pivoting attachment assemblies (typically having a bucket attached) that can be operated while maneuvering the skid loader. Such skid loaders are thus well-suited for precision landscaping operations, and are particularly well-suited for work in confined areas.

The inventor previously patented a landscaping apparatus in U.S. Pat. No. 7,287,344 (the '344 patent). The '344 patent is hereby incorporated herein by reference. As described in the '344 patent, the prior art lacked multi-purpose attachments for skid loaders and other landscaping equipment that would permit full utilization of the vehicles. For example, several rake attachments are known, such as those described in U.S. Pat. No. 6,360,458 to Dolister and U.S. Pat. No. 5,515,625 to Keigley. However, the use of these known rakes is limited by their structure and features. For example, the attachment disclosed in Dolister can only be used as a rake when the skid loader bucket is elevated and tipped forwardly. However, with the bucket raised and tipped, driver visibility of the soil being worked is compromised. Additionally, reduced forward clearance results from the forwardly tipped bucket, preventing the use of the device in a zero-tolerance environment such as in very close proximity to a building foundation or poured concrete sidewalk. In addition, the one-dimensional rake invention described in Dolister includes just one working surface that can be mounted and used in a single configuration.

Similarly, the rake and scarifying attachment disclosed by Keigley is appropriate for a very limited number of applications as a result of its features and configuration. For example, while the apparatus disclosed in Keigley provides two sets of separate working surfaces, the configuration and arrangement of the rake and scarifying teeth prevent use of either in a zero-clearance environment. Additionally, installation and use of the Keigley apparatus is cumbersome. For example, installation of the Keigley apparatus first requires removal of the bucket of the vehicle, which removal is time-consuming, and potentially dangerous. Removal of the bucket also severely compromises the utility of the skid loader. For example, no large rocks, other debris, or soil loads can be transported when the Keigley attachment is installed on the skid loader.

The '344 patent alleviated some of the unmet need for a single landscaping tool that is suitable for attachment to a wide variety of landscaping vehicles such as all-terrain skidloaders, tractor loaders, backhoes, tractors, bulldozers, and other landscaping vehicles. The '344 patent provided a landscaping tool that can be selectively mounted on a material handling vehicle in multiple orientations or configurations to permit use in a wide variety of landscaping functions such as of grading, filling, leveling, scarifying, and vegetation removal. The '344 patent further provided a tool that can be easily transported and easily installed to provide more than one working surface. However, the '344 patent did not meet some very important needs that the inventor has since identified and solved. In particular, the '344 patent provided limited means for mounting the tool to the bucket of landscaping equipment. There exists a continuing need for landscaping tools and apparatus and methods of mounting the tools that provide for easy, secure, and removable mounting on a landscaping vehicle, preferably by a single person.

Furthermore, there is a continuing and unmet need for an attachment that can be removably installed and used without removing or compromising the utility of the bucket of the landscaping vehicle, and without requiring mounting holes to be provided on the landscaping bucket itself. Lastly, there is a continuing need for a secure attachment means in conjunction with a landscaping tool that provides zero-tolerance raking and landscaping tasks without compromising front clearance or operator visibility.

### SUMMARY OF THE INVENTION

In one embodiment, the invention is an improved apparatus for attachment to landscaping equipment, the apparatus comprised of: an elongate plate having a first longitudinal edge, a second opposite longitudinal edge, and a middle plate portion disposed between the first longitudinal edge and the second opposite longitudinal edge; wherein the first longitudinal edge includes a plurality of teeth, each tooth separated from the adjacent tooth by a trough; the second longitudinal edge includes a plurality of teeth, each tooth separated from the adjacent tooth by a trough; and the middle portion, the improvement comprising at least one mounting bracket protruding from the elongate plate. Optionally, the improvement further comprises the elimination of apertures in the elongate plate, since no apertures are now required for mounting the tool to the bucket attachment of a landscaping vehicle.

In another embodiment, the invention is a load securing apparatus for removable attachment of a landscaping tool to the bucket of a landscaping vehicle, the apparatus comprising a flexible tensioning apparatus and a durable tensioning apparatus. The load securing apparatus further includes an adjustable tension mechanism linked to at least one of the flexible tensioning apparatus or the durable tensioning apparatus. The flexible tensioning apparatus and durable tensioning apparatus each include means for engaging a landscaping tool to securely fasten the tool to the bucket of a landscaping vehicle. In one embodiment, the flexible tensioning apparatus includes webbing, strapping, or wire rope. In another embodiment, the adjustable tensioning mechanism includes at least one of a ratchet-type mechanism or a winch.

A method for attaching a landscaping tool to the bucket of a landscaping vehicle is provided. In one embodiment, the method provides for the steps of providing a landscaping tool comprised of an elongate plate having a first longitudinal edge, a second opposite longitudinal edge, and a middle plate portion disposed between the first longitudinal edge and the second opposite longitudinal edge, wherein the first longitudinal edge includes a plurality of teeth, each tooth separated from the adjacent tooth by a trough, and wherein the second longitudinal edge includes a plurality of teeth, each tooth separated from the adjacent tooth by a trough; wherein the first longitudinal edge and second opposite longitudinal edge are offset at a preselected angle, the tool comprising at least one mounting bracket protruding from the elongate plate. The method further includes mounting the landscaping tool to the bottom lip of a bucket attachment of a landscaping vehicle by engaging the lip to at least one mounting bracket provided on the tool, then securing the tool to the bucket by connecting to the mounting bracket an apparatus comprising an adjustable tension mechanism linked to at least one flexible tensioning apparatus or durable tensioning apparatus, each of the flexible tensioning apparatus and durable tensioning apparatus including means for engaging the landscaping tool to securely fasten the tool to the bucket of a landscaping vehicle. The method further includes operating the tensioning mechanism to tighten the flexible tensioning apparatus around the bucket.

### BRIEF DESCRIPTION OF THE DRAWINGS

FIG. 1 is a perspective view of an apparatus in accordance with the present invention.

FIG. 2 is a side elevation of an apparatus in accordance with the present the invention.

FIG. 3 is a fragmentary perspective view of an apparatus in accordance with the present invention.

FIG. 4 is a side elevation of an apparatus in accordance with the present invention, showing support during mounting using a wood block to achieve proper alignment with a bucket cutting edge.

FIG. 5 is a side elevation of an apparatus in accordance with the present invention attached to a loader bucket using a load securing device of the present invention.

### DETAILED DESCRIPTION

As previously described, the inventor is also the inventor of the '344 patent. Among other advantages, benefits over the inventions of the '344 patent include eliminating the need for pre-existing holes in the bottom of the bucket which must precisely correspond to holes in the landscaping apparatus of the '344 patent. Another advantage of the present invention is the elimination of the need for extra tools associated with tightening and loosening of bolts through apertures in the bucket and tool of the '344 patent. Another advantage is the elimination of the precarious task of manually lifting and positioning the landscaping apparatus during installation for the purpose of lining up the connection holes as required in the '344 patent. The requirement of mounting apertures and associated alignment requirements limits the '344 patent landscaping apparatus in terms of size and weight that can safely be handled during installation by any one person. Other advantages of the improvements described herein include trimmable expansion tabs located on mounting brackets, thus making the landscaping apparatus compatible with thicker bucket edges. This feature increases compatibility without adding any extra steps to the installation process of the '344 patent apparatus or other tools, such as manipulation of clamping devices connected to the landscaping vehicle.

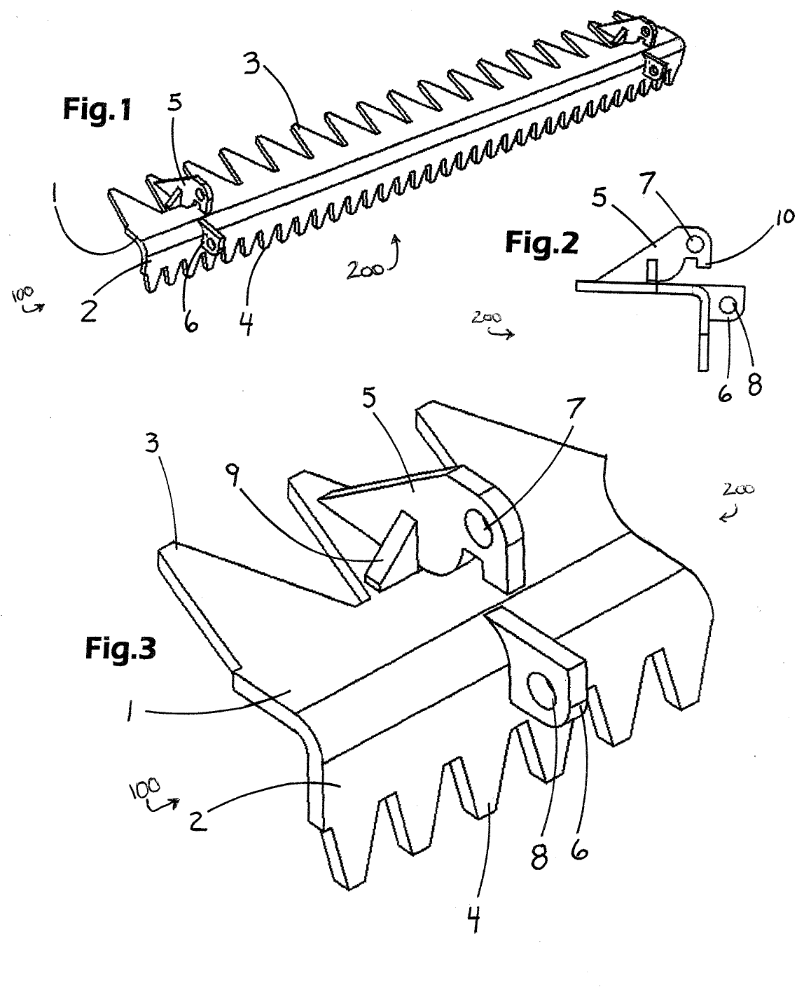

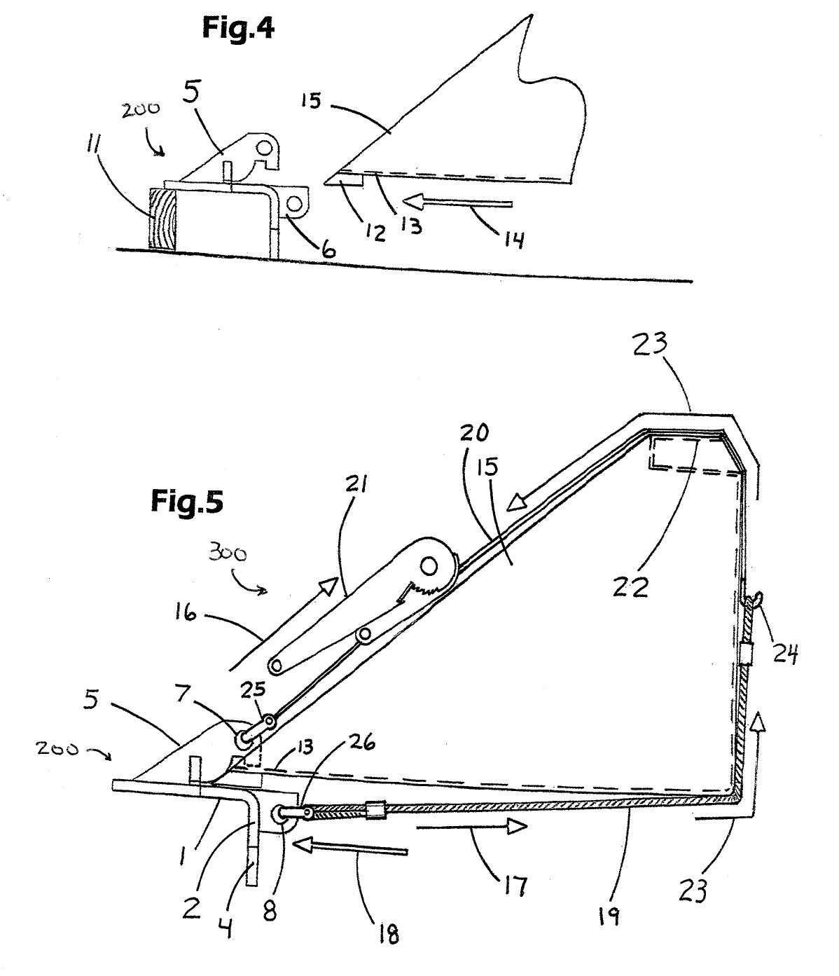

The apparatus of the present invention is comprised of a supporting framework that can be easily and removably mounted onto a variety of landscaping vehicles and other lifting equipment such as, but not limited to, backhoes, tractors, skid loaders, all-terrain vehicles, trucks, and the like. By way of example, FIGS. 1-3 illustrate views of a first embodiment of the apparatus of the present invention, while FIGS. 4-5 illustrate apparatus and methods of mounting such a tool on an all-terrain skid loader in various positions, using mounting brackets and removable load securing apparatus as described herein. While an all-terrain vehicle such as a skid loader or a tractor is preferred, any motorized vehicle having a lift apparatus and a mounting surface such as a bucket or an attachment mounting plate or the like can be used to support, maneuver, and operate the apparatus of the preset invention.

Referring now to the drawings, FIG. 1 shows a preferred embodiment of the present invention. The tool 200 generally comprises an elongate plate having a first surface 1, a second surface 2, and a plurality of teeth 3, 4 on each respective surface 1, 2. The width and thickness of the plate 200 can be varied to allow different lengths and types of rake teeth and scarifying teeth while providing rigidity and durability characteristics to the tool 200. In one embodiment, the plate 12 has a width between approximately eight to ten inches, and a thickness of about ½ inch to provide sufficient strength for enduring continuous raking engagement with a soil surface. In this regard, the tool 200 is similar to the tools described in the '344 patent. The improvements over that tool include the optional elimination of mounting holes in the plate 100, with mounting means provided instead by at least one mounting bracket attached to the tool 200, and preferably to plate 100. More preferably, the at least one mounting bracket includes a plurality of mounting brackets 5, 6. Even more preferably, the plurality of mounting brackets are selected and arranged to collectively and equally engage the first surface 1 and second surface 2 of plate 100. Most preferably, the plurality of mounting brackets are spaced along the longitudinal length of plate 100 so as to permit secure and even tension when attached to a mounting bucket 15 of a landscaping vehicle.

As described in the '344 patent, the tool 200 includes a plurality of teeth project along a first longitudinal edge of the plate 100. The teeth may have squared or sharpened ends, but preferably have radiused points. Between adjacent teeth are provided troughs which connect the adjacent teeth. In the preferred embodiment, the teeth form a scarifying rake having has approximately four to five teeth per foot. The teeth generally project from the plate edge approximately five to six inches, and have the same thickness as the plate. While the aforementioned dimensional ranges for the scarifying rake, particularly the length, teeth per foot and tooth length, are the preferred ranges for a scarifying rake for a skid steer loader, the present invention can be employed with dimensions outside of these preferred ranges. For example, the teeth may be of different lengths, and may be interspersed along the length of the edge in a preselected pattern to provide a uniform pattern of alternating, ascending or descending lengths and/or widths, much as known scarifying tools and rakes have varying configurations.

As described in the '344 patent, the tool 200 further includes a second longitudinal edge. In one embodiment, the second longitudinal edge is provided on the end of surface 2 of the plate 100 opposite the first surface 1. The second edge includes a plurality of teeth having terminal points that can be squared, radiused or sharpened, but that preferably have squared terminal points. Between adjacent teeth are provided troughs which connect the adjacent teeth. In a preferred embodiment, the second edge has teeth that form a rake with teeth having substantially uniform length, width, and spacing as compared to the teeth of the first edge. The teeth preferably project from the plate a sufficient length so as to permit use in raking and similar landscaping tasks. Preferably, the teeth extend at least one inch, and have approximately the same thickness as the plate.

While the aforementioned dimensional ranges for the tool 200, particularly the length, teeth per foot and tooth length, are the preferred ranges for a rake and scarifying attachment for a skid steer loader, the present invention can be employed with dimensions outside of these preferred ranges. For example, the teeth 3, 4 may be of different lengths, and may be interspersed along the length of the respective edges in a preselected pattern to provide a uniform pattern of alternating, ascending or descending lengths and/or widths, much as known scarifying tools and rakes have varying teeth configurations.

Similar to the apparatus in the '344 patent, in the preferred embodiment, the plate 100 is a single plate cut from a unitary plate of solid steel material in a single plasma cutting operation. This method of manufacture provides suitable strength and durability of the individual teeth 3,4 and the tool 200 as a whole. In this embodiment, because the tool 200 is a unitary plate 100 member which can be attached by conventional fasteners, the tool 200 is very cost efficient and inexpensive relative to other prior art attempts. Additionally, in this embodiment, multiple tools 200 may be plasma cut from steel plate stock, thereby greatly reducing scrap material.

However, in this improved tool 200, there is no requirement for mounting holes provided in the plate. Rather, mounting brackets 5, and 6, are provided. As shown in FIGS. 1-3 in a preferred embodiment, the mounting brackets 5, 6 include apertures 7,8 for receiving a load securing apparatus 300. The tool 200 is mounted to the edge 12 of the lower surface 13 of a bucket 15, such as the bucket of a landscaping vehicle of any type or size. The mounting position shown in FIGS. 4-5 shows teeth 3 pointing forwards and teeth 4 pointing downwards. However, by altering, changing, repositioning, or otherwise adjusting the direction of mounting brackets 5,6, the tool 200 can be mounted with teeth 3,4 facing in any inward, downward, upward, or outward position relative to bottom surface 13 or bucket 15. For example, the mounting bracket 5,6 may be mounted to allow swiveling, rotating, or other motion relative to stationary plate 100 to permit mounting of tool 200 in various selected orientation relative to bucket 15.

FIGS. 4-5 show a preferred embodiment of the tool 200 being removably installed on a skid steer loader having a bucket attachment 15. However, the tool 200 is designed to be removably mounted to the bucket 15 of virtually any landscaping vehicle. The bucket 15 includes a front lip 12 along bottom surface 13. The front lip 12 can include a fixed or removable edge. AT least one mounting bracket, here bracket 5, includes slot means formed by a tab 10, and preferably bounded by plate 100 and a second mounting bracket 6. More preferably, tab 10 is provided in a length to fit a thin edge 12, but can be trimmable (such as by providing perforations, differing patters, etc, In tab 10) to allow the slot to be enlarged to fit buckets having thicker edges 12. In this manner, tab 10 can be trimmed to correspond with the particular bucket attachment 15 and bottom surface 13 as well, based on the manufacturer and bucket size. These features are best seen in FIG. 2-3.

Further referring to FIGS. 4-5, methods are provided for converting a bucket 15 into a rake and/or scarifying attachment implement. The methods include the steps of providing the proper tool 200 based on the manufacture and size of the bucket attachment 15, aligning the tool 200 and bucket attachment 15 such that the teeth project in the desired orientation from the front of the bucket 15 and such that a select number or all of the mounting brackets 4, 5 are in alignment with the lip 12. In FIG. 4, a prop such as a wooden block 11, can be provided to orient the tool 200 in a manner to align the slot under tab 10 in the mounting bracket 5 with lip 12.

As shown in FIG. 5, the methods further provide for attaching a load securing device 300 to one or all of the mounting brackets 4.5 to secure the tool 200 to the front lip 12 of the bucket attachment 15. In the preferred embodiment, this step is accomplished by providing a load securing device or apparatus 300 having flexible tensioning means linked to a tensioning mechanism. In FIG. 5, the flexible tensioning means 20 are illustrated as webbing or strapping having first attachment means 25 on one end for engaging the mounting aperture 7 in bracket 5, and having a second attachment means 24 on an opposite end of strapping 20 for engaging a durable tensioning means 19. While webbing or strapping is illustrated for flexible tensioning means 20, flexible tensioning means can alternatively be any combination of ropes, cords, strapping, webbing, cables, chains and/or other material capable of providing tension in a substantially axially and/or linear direction. However, with respect to durable tension means 19, the juxtaposition below the bucket 15 and bottom edge 13 increases the likelihood of contact with ground, rocks, and other abrasive materials, making metal or strong, durable synthetic materials most preferable. Additionally, the need for flexible tensioning means 20 and durable tensioning means 19 to tightly engage the outer surface of bucket 15 to secure the tool 200 during use of the tool requires the load securing apparatus 300 to provide constant tension against any or all types and directions of exerted and force, exemplary forces represented in FIG. 5 as 16, 17, 18, and 23 during operation. Thus, maximum contact of flexible tensioning means 20 and durable tensioning means 19 to the outer surface of bucket 15 is desired, making flexibility around acute edges important. For this reason, and depending upon the shape and strength of bucket 15, non-sliding tensioning means such as chains, which may bind around acute corners of a bucket 15, are not the most desirable. Of course, the length of means 19, 20 can be selected to adjust the location and type of connection(s) between the flexible tension means 20 and durable tension means 19 to avoid binding around any weak or thin wall portions 22 of bucket 15. Preferably, only the flexible tensioning means 20 is linked to a tensioning mechanism 21, with the durable tensioning means 19 being connected to the tool 200 and the flexible tensioning means, as shown in FIG. 5.

A tensioning mechanism 21 is included for tightening the tensioning means 20, 19. In FIG. 5, the tensioning mechanism 21 is illustrated as a ratchet mechanism engaging strapping 20 and 21. However, other known tensioning mechanisms compatible with flexible tensioning means and/or durable tensioning means are within the scope of the invention. By way of non-limiting example, turnbuckles and other threaded tightening apparatus, winches, ratcheted spools and gears, whether automatic, electric, or manually powered and operated, are within the scope of the invention. Additionally, the tensioning mechanism may be free-floating (as in the ratchet and strap embodiment shown in FIG. 5), or may be mounted on the tool 200, the bucket 15, and/or the landscaping vehicle. More than one tensioning mechanism 21 may be provided, such as one for tensioning the flexible tensioning apparatus 20 and one for tensioning the durable tensioning apparatus 19. Optionally, a tensioning mechanism(s) 21 may include one already provided on a vehicle, such as a hydraulic or electric winch for engaging any part of the load securing apparatus 300 or tool 200. Tensioning mechanism 21 may include optional features such as a removable handle, much like strapping mechanisms provided on flatbed trucks to secure large loads.

Due to the unique configuration of two opposite longitudinal working edges on tool 200, combined with the load securing device 300 as described herein, the present invention has the ability to be utilized on a landscaping vehicle bucket while operating in “backward or forward” direction with the bottom surface 13 of the bucket 15 remaining parallel to the ground. When the landscaping apparatus is operated in a backward direction, the bottom surface 13 of bucket 15 and bottom surface 4 are subjected to a large amount of force 18 which is applied by the build up of rocks, soil and vegetation underneath the bucket. Without the durable tensioning member 19 of load securing device 300, the lack of an adequate counteracting force 17 applied to the bottom surface 13 would result in the top mounting bracket 5 becoming disengaged from the bucket lip 12. Many types of load securing devices such as those which transfer tension with the use of linked chain could be used to connect the tool 200 to a bucket 15. However, although durable, linked chain is not the most efficient means of delivering tension around the sharp angles of the back corners of the bucket 15. The segmented oval design and rigid structure of individually connected chain links lack the continuous flexibility that is required to efficiently transfer tension around sharp angles. Also, the focused tensioning pressure from the linked chain can damage unsupported flanges that protrude outward from the back of many buckets. Because wire rope is constructed from metal it shares the same durability characteristics of linked chain which resists damage when positioned underneath the bucket 15. For these reasons, the preferred load securing device is one that utilizes synthetic strapping around the top back edge 22 of the bucket 15 connected to a durable tensioning member 19 such as a wire rope which is routed around the bottom back edge of the bucket 15. The highly flexible nature of strapping and wire rope are well-suited for transferring tension around sharp angles. Additionally, wide strapping is less likely to damage the unsupported flanges 22 that protrude outward from the back of the bucket 15 because the tensioning pressure is spread out over a wider area. Optionally, a plate can be provided under the strapping to spread force across the surface of bucket 15, such as on an unsupported flange 22.

Similarly, the rake and scarifying attachment 10 may be removed from the bucket attachment 40 by removing the apparatus 300. Additionally, although the apparatus has been described in a few preferred embodiments, the tool 200 plate 100 can still include a plurality of mounting apertures configured for vertically orienting the tool, and/or a set of mounting apertures configured for horizontally mounting the tool 100 as in the '344 patent. Once removed, the rake and scarifying tool 200 can be removably secured to a second bucket attachment using the methods described herein. The size and scale of the apparatus and its components are contemplated within a wide range in order to meet the needs of the landscaping industry. For example, the apparatus may be provided with varying widths and having various sizes and arrangements of teeth.

While the invention is described in terms of raking and scarifying, the apparatus and methods are equally applicable to removal of brush and other landscaping tasks wherein scarifying teeth and rakes can be utilized. Alternatively, or additionally, where differing teeth configurations are provided on each working edge of the tool, the operator can selectively engage either working surface to change tasks without removing or repositioning the tool, such as scarifying by tipping the bucket forward to engage an edge having scarifying teeth, then raking by tipping the bucket back to its horizontal position to engage downwardly pointing rake teeth on a second edge of the tool.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An improved landscaping tool for attachment to landscaping equipment, the tool comprised of: an elongate plate having a first longitudinal edge, a second opposite longitudinal edge, and a middle plate portion disposed between the first longitudinal edge and the second opposite longitudinal edge; wherein the first longitudinal edge includes a plurality of teeth, each tooth separated from the adjacent tooth by a trough; the second longitudinal edge includes a plurality of teeth, each tooth separated from the adjacent tooth by a trough; and the middle portion, wherein the first longitudinal edge and second opposite longitudinal edge are offset at a preselected angle, the improvement comprising at least one mounting bracket protruding from the elongate plate.

2. The apparatus of claim 1, wherein the mounting bracket includes means for engaging the lip of a bucket compatible with a landscaping vehicle, wherein the means for engaging does not require providing apertures in the elongate plate to correspond with apertures in the bucket.

3. The apparatus of claim 1, wherein the at least one mounting bracket is configured to engage the lip of a bucket of a landscaping vehicle.

4. The apparatus of claim 3, wherein the at least one mounting bracket is adjustable to engage lips of varying thicknesses and shapes.

5. The apparatus of claim 3, wherein the mounting bracket is trimmable to engage lips of varying thicknesses and shapes.

6. The apparatus of claim 1, wherein the at least one mounting bracket comprises at least one mounting bracket mounted to the middle portion adjacent the first edge, and at least one mounting bracket mounted to the middle portion adjacent the second edge.

7. The apparatus of claim 6, wherein at least one mounting bracket includes means for engaging the lip of a bucket of a landscaping vehicle, wherein the means does not include apertures in the elongate plate for engaging with holes provided in the bucket.

8. The apparatus of claim 7, wherein the at least one mounting bracket is configured to engage the lip of a bucket of a landscaping vehicle.

9. The apparatus of claim 8, wherein the at least one mounting bracket is adjustable to engage lips of varying thicknesses and shapes.

10. The apparatus of claim 9, wherein the mounting bracket is trimmable to engage lips of varying thicknesses and shapes.

11. A load securing apparatus for removable attachment of a landscaping tool of claim 1 to the bucket of a landscaping vehicle, the load securing apparatus comprising a flexible tensioning apparatus and a durable tensioning apparatus, the load securing apparatus further comprising a adjustable tension mechanism linked to at least one of the flexible tensioning apparatus or the durable tensioning apparatus, the flexible tensioning apparatus and durable tensioning apparatus each including means for engaging a landscaping tool to securely fasten the tool to the bucket of a landscaping vehicle.

12. The apparatus of claim 11, wherein the flexible tensioning apparatus includes at least one of webbing, strapping, or wire rope, and wherein the durable tensioning apparatus includes at least one of cable or wire rope.

13. The apparatus of claim 11, wherein the adjustable tensioning mechanism includes at least one of a ratchet-type mechanism or a winch.

14. The apparatus of claim 13, wherein the adjustable tensioning mechanism is free floating.

15. The apparatus of claim 11, wherein the adjustable tensioning mechanism is mounted to either the landscaping tool or a landscaping vehicle.

16. A method for attaching a landscaping tool to the bucket of a landscaping vehicle, the method comprising the steps of:
providing the improved landscaping tool of claim 1;
mounting the landscaping tool to the bottom lip of a bucket attachment of a landscaping vehicle so that the lip engages at least one mounting bracket; and
securing the tool to the bucket by connecting the mounting bracket to the load securing apparatus of claim 11.

17. The method of claim 16, further including the step of operating the tensioning mechanism to tighten the flexible tensioning apparatus around the bucket.

18. The method of claim 16, wherein all steps are performed by less than two persons.

19. The method of claim 16, wherein all steps are performed by one person.

20. The method of claim 17, wherein all steps are performed by less than two persons.
